(19) United States
(12) Patent Application Publication
(10) Pub. No.: US 2025/0276340 A1
(43) Pub. Date: Sep. 4, 2025

(54) DEVICE FOR APPLYING A VISCOUS MATERIAL

(71) Applicant: Atlas Copco IAS GmbH, Bretten (DE)

(72) Inventors: Thomas HAUSNER, Bretten (DE); Gerrit ENDERLE, Knittlingen (DE); David JAEGER, Bruchsal (DE)

(73) Assignee: Atlas Copco IAS GmbH, Bretten (DE)

(21) Appl. No.: 18/850,159

(22) PCT Filed: Feb. 17, 2023
(86) PCT No.: PCT/EP2023/054005

§ 371 Date: Sep. 24, 2024

(30) Foreign Application Priority Data
Mar. 25, 2022 (DE) 10 2022 107 153.7

(51) Int. Cl. B05C 5/02; B05D 1/26

(52) U.S. Cl. CPC B05C 5/0291; B05D 1/26

(57) ABSTRACT

A device for applying a viscous material to workpieces, has a nozzle holder and an applicator nozzle which is arranged on the nozzle holder and has a material line extending from a material inlet, for introduction of the viscous material, to a nozzle opening for emergence of the viscous material. The material line has an inlet portion, extending in a first direction from the material inlet, and an outlet portion, extending to the nozzle opening in a second direction transverse to the first direction, and the applicator nozzle is mounted on the nozzle holder pivotably about a pivot axis forming a longitudinal center axis of the inlet portion.

The invention relates to an apparatus for applying a viscous material to workpieces, in accordance with the preamble of claim 1.

Such apparatuses serve, in particular, for applying viscous materials to workpieces in automobile production. Possible viscous materials are, for example, adhesives, sealants, insulation materials or heat-conductive pastes. Application apparatuses of the type stated initially are generally mounted on an arm of an industrial robot for this purpose, and guided along an application path by this arm, at a distance from the workpiece, over the workpiece surface. The material is then applied to the workpiece in a material bead that runs along the application path, continuously or with interruptions, which bead is typically straight in certain sections and curved in certain sections. In order to widen the material bead, what are called swirl application apparatuses are used, for example. Such an apparatus according to the preamble of claim 1 is known, for example, from EP 0 852 160 B1. Its application nozzle has an application pipe that is mounted in an eccentric mechanism close to its end that has the nozzle opening, which eccentric mechanism is put into rotation about its longitudinal center axis during the application process and imposes a circular motion on the eccentrically mounted application pipe at the nozzle opening. This circular motion, which takes place at several thousand revolutions per minute, allows centrifugal forces to act on the viscous material, which forces lead to a spiral-shaped movement of the material stream. This brings about a circular material application and leads to widening of the applied material bead, so that the latter is significantly wider than the diameter of the nozzle opening. However, it is a disadvantage of such apparatuses that air inclusions are formed between the circles of the applied material that are superimposed on one another, during pressing of the coated workpiece with a further workpiece, which inclusions make planar pressing of the viscous material more difficult. Such air inclusions are avoided if the material is applied to the workpiece in a zigzag-shaped bead, so that the air can escape to the left and to the right of the zigzag bead when two workpieces are pressed together. In order to achieve a zigzag-shaped bead, attempts were made to deflect a flexible material line transverse to its longitudinal expanse, alternately in opposite directions, by means of a motor drive. However, in the case of high material pressures in the material line, this line is so stiff that great motor power is required for its deflection.

It is therefore the task of the invention to further develop an apparatus of the type stated initially, in such a manner that a material application that covers a larger surface area can be achieved in a simple manner.

This task is accomplished, according to the invention, by means of an apparatus having the characteristics of claim 1. Advantageous further developments of the invention are the object of the dependent claims.

The invention is based on the idea of allowing the material to enter into the material line in the first direction and of deflecting it in the material line, so that it can exit again in the second direction. In this regard, the inlet section that runs in the first direction serves as a hollow shaft, about the longitudinal center axis of which the application nozzle is pivoted back and forth, so as to move the nozzle opening back and forth by means of this movement. In this way, the material can be applied to the workpiece in a zigzag-shaped bead, without the robot arm that carries the application apparatus having to perform a complicated movement in this regard. By means of pivoting the application nozzle about the pivot axis, the material bead can furthermore be guided around a barrier that is situated in the application path, without the robot having to deviate from this application path. The deflection about the longitudinal center axis of the hollow shaft requires significantly lower power, in this regard, than the deflection of a flexible material line in which material flows under high pressure.

It is practical if the inlet section and the outlet section are rigidly linked. This rigid configuration of the material line facilitates the deflection by means of pivoting about the pivot axis. Furthermore, it is preferred that the second direction runs perpendicular to the first direction, so that the two enclose a right angle. This measure allows avoiding an imbalance, to a great extent, in particular if the application nozzle has an equalization part that extends transverse to the inlet section and lies opposite to the outlet section with reference to the pivot axis, as it does in accordance with an advantageous further development of the invention. It is practical if the equalization part extends counter to the second direction, and its mass preferably corresponds to approximately the mass of the outlet section, wherein it particularly deviates from it by at most 20% and preferably by at most 10%. The equalization part forms an equalization mass to prevent an imbalance when the application nozzle pivots back and forth about the pivot axis.

It is practical if a motor is provided to pivot the application nozzle about the pivot axis, in particular an electric motor, which is configured, for example, as a stepper motor or electromagnetic drive. It is practical if the motor is firmly connected to the nozzle holder, so as to be able to pivot the application nozzle with regard to the pivot axis. For this purpose, it is practical if the application nozzle has an extension that projects away from the side that faces away from the inlet part, through which extension the pivot axis extends. In this regard, it is practical if the pivot axis coincides with a longitudinal center axis of the extension. Engagement with this extension can take place to pivot the application nozzle, and, in particular, the extension can be connected to a drive shaft of the motor. The extension furthermore serves for better mounting of the application nozzle on the nozzle holder, wherein preferably the inlet section and the extension are each mounted on the nozzle holder in a rotational bearing. Mounting of the application nozzle on both sides of the outlet section and, if applicable, of the equalization part, stabilizes the application nozzle in the nozzle holder and further reduces the imbalance. In this regard, a first one of the rotational bearings can advantageously be a ball bearing, preferably a double-row deep groove ball bearing or an angular ball bearing. Furthermore, a second one of the rotational bearings can be a body made of plastic, in which the extension or the inlet section is accommodated. The plastic body can consist of a friction-reducing plastic, so that the friction forces when pivoting the application nozzle are minimized. The plastic body can furthermore have recesses on its surface that faces the extension or the inlet section, so as to minimize the contact surface with the application nozzle.

It is practical if a feed line for the material, which line is locally fixed in place with reference to the nozzle holder, is provided, and has an end section that opens into the inlet section. It is practical if this end section has a longitudinal center axis that is a continuation of the longitudinal center axis of the inlet section, so that the two longitudinal center axes coincide. The inlet section then acts as a continuation of the feed line and is rotated about the common longitudinal center axis with reference to it when the application nozzle is pivoted about its pivot axis in the nozzle holder. To prevent adhesions of the viscous material on the inlet section, it is advantageous if a circumferential sealing ring is arranged between the inlet section and the end section, which ring preferably consists of polytetrafluoroethylene (PTFE). In this regard, it is preferred that the sealing ring lies loosely against an end face of the inlet section that faces the end section and against an end face of the end section that faces the inlet section. In order to retain material that exits at the connection location between the end section and the inlet section, due to possible leaks, it is practical if a sealing ring that is arranged fixed in place with reference to the nozzle holder is arranged around the inlet section, which ring is preferably produced from a polyethylene having an ultra-high molecular weight and a high density (PE-UHMW).

It is practical if means arranged on the nozzle holder, for limiting a pivot angle about which the application nozzle can be pivoted about the pivot axis with reference to the nozzle holder, are provided. These means for limiting the pivot angle can be adjustable, in order to vary a maximum pivot angle. In this way, the maximum pivot angle about which the application nozzle can be pivoted with reference to the nozzle holder can be specifically adapted to the requirements that exist in the area of application, in each instance.

In the following, the invention will be explained in greater detail using an exemplary embodiment shown schematically in the drawing. The figures show:

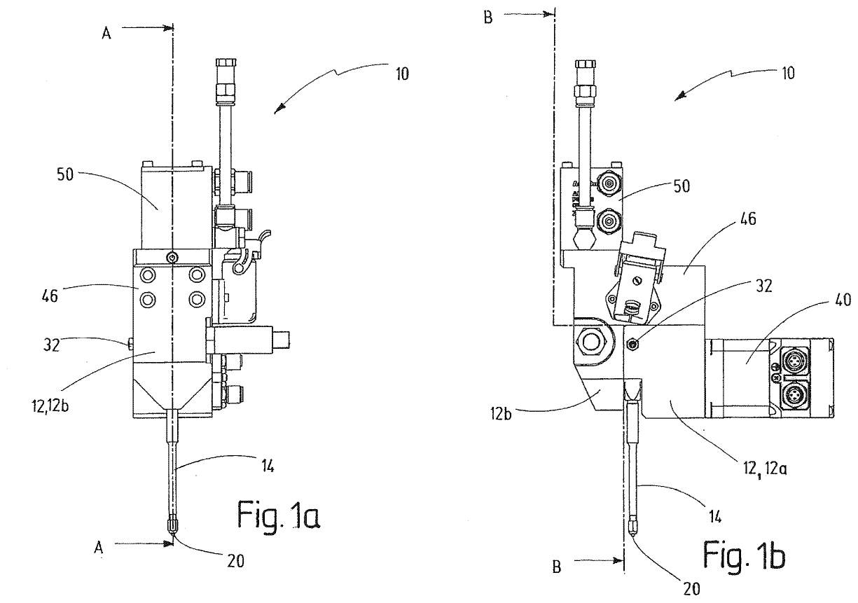

FIG. 1a, b an apparatus for applying a viscous material, in a front view and a side view;

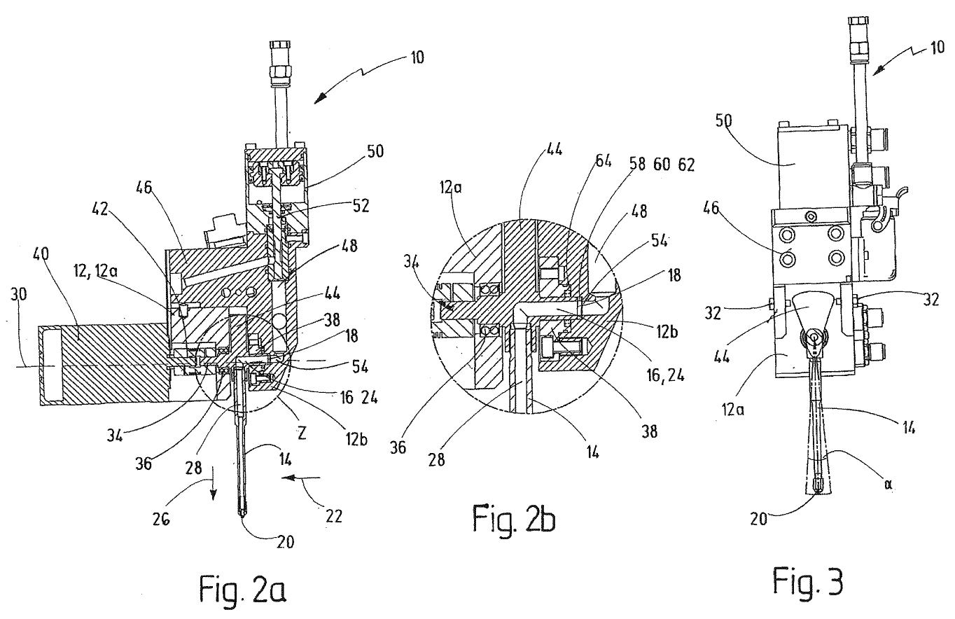

FIG. 2a a section along the line A-A according to FIG. 1a;

FIG. 2b an enlargement of the detail z in FIG. 2a, and

FIG. 3 a section along the line B-B according to FIG. 1b.

The apparatus 10 for applying a viscous material, shown in the drawing, referred to in short form as application apparatus 10 in the following, has a nozzle holder 12 composed of two parts 12a, 12b that are releasably connected to one another, as well as an application nozzle 14 for the viscous material, mounted on the nozzle holder 12, which material can be, in particular, an adhesive, a sealant, an insulation material or a heat-conductive paste. The application nozzle 14 has a material line 16 that extends from a material inlet 18, at which the viscous material is introduced into the application nozzle, all the way to a nozzle opening 20, from which the viscous material exits from the application nozzle 14. The material line 16 is divided into an inlet section 24 that extends in a first direction 22, proceeding from the material inlet 18, and into an outlet section 28 that follows the inlet section 24 and extends in a second direction 26 all the way to the nozzle opening 20. In this regard, the first direction 22 and the second direction 26 stand perpendicular to one another and enclose a right angle. In this regard, this right angle is not changeable, since the inlet section 24 and the outlet section 28 are rigidly connected to one another.

The application nozzle 14 is mounted so as to pivot on the nozzle holder 12, between a first holder part 12a and a second holder part 12 that is releasably connected to the first, wherein the longitudinal center axis of the inlet section 24 forms the pivot axis 30. Means 32 arranged in the nozzle holder 12, for limiting the pivot range of the application nozzle 14, are configured as stop elements and limit the maximum pivot angle α by making contact with the application nozzle 14 when it is pivoted about the pivot axis 30. The limitation means 32 are accommodated in the nozzle holder 12 so that their position is changeable, so that the maximum pivot angle α can be varied by means of varying their position. In a continuation of the inlet section 24, the application nozzle 14 has an extension 34 that projects on the side of the outlet section 28 that faces away from the inlet section 24, the longitudinal center axis of which extension is also defined by the pivot axis 30, and which extension is mounted to rotate in a first rotational bearing 36 in the first holder part 12a, configured as a double-row deep groove ball bearing, while the inlet section 24 is mounted to rotate about the pivot axis 30 in a second rotational bearing 38 formed by a plastic body, arranged in the second holder part 12b. The plastic body that forms the second rotational bearing 38 consists of a friction-reducing plastic and furthermore has recesses on the surfaces that face the inlet section 24, so as to minimize the contact surface with the inlet section 24 and further reduce the friction. On the first holder part 12a, an electric motor 40 configured as a stepper motor is furthermore releasably attached; its drive shaft 42 is releasably and firmly connected to the extension 34, so that the application nozzle 14 can be pivoted about the pivot axis 30 by means of the electric motor 40. In a continuation of the outlet section 28, the application nozzle 14 has an equalization part 44 on the side of the inlet section 24 that faces away from the outlet section 28, projecting away, the mass of which part approximately corresponds to the mass of the outlet section 28, to reduce an imbalance that occurs when the application nozzle 14 is pivoted about the pivot axis 30.

The application apparatus 10 furthermore has a feed line part 46 that is releasably connected to the two holder parts 12a, 12b, wherein a feed line 48 for the viscous material extends through the feed line part 46 and the second holder part 12b to the material inlet 18. A needle valve 50 is set onto the feed line part 46 and releasably attached to it, which valve is configured as a snuff-back valve, and the valve needle 52 of which valve closes off the feed line 48 by setting down onto a valve seat. An end section 54 of the feed line 48, which section opens into the inlet section 24 at the material inlet 18, once again extends in the first direction 22, so that its longitudinal center axis coincides with the longitudinal center axis of the inlet section 24, the longitudinal center axis of the extension 34, and the pivot axis 30. A pressure sensor, not shown in any detail, is arranged in the end section 54.

A first sealing ring 58, composed of polytetrafluoroethylene (PTFE) is arranged in the nozzle holder 12 between the end section 54 and the inlet section 24, which ring lies loosely against the end face 60 of the inlet section 24, which faces the end section 54, and also loosely against the end face 62 of the end section 54, which faces the inlet section 24. Furthermore, a second sealing ring 64 composed of a polyethylene with ultra-high molecular weight and high density (PE-UHMW) is accommodated in the second holder part 12b, so as not to rotate; this ring lies against the inlet section 24 all around, forming a seal, and prevents an escape of viscous material from the rotary feed-through formed by the transition from the end section 54 to the inlet section 24.

To apply a viscous material to a workpiece, the apparatus 10 is mounted on a robot that moves the apparatus 10 along an application path with reference to the workpiece, wherein the nozzle opening 20 is held at a distance from the surface of the workpiece. A control device controls the electric motor 40 as a function of the speed of the apparatus 10 with regard to the workpiece, so that this motor pivots the application nozzle 14 about the pivot axis 30, so as to achieve a predetermined application pattern. In particular, the electric motor 40 brings about a back-and-forth movement or pendulum movement of the application nozzle 14 if the material is supposed to be applied in a zigzag pattern, wherein if necessary, the amount of the deflection can also be varied by means of a variation of the pivot angle α, in the same way as the frequency of the deflection can be varied, in particular in the case of changes in velocity. Asymmetrical or one-sided deflections can also be controlled.

In summary, the following should be stated: The invention relates to an apparatus 10 for applying a viscous material to workpieces, having a nozzle holder 12 and an application nozzle 14 arranged on the nozzle holder 12, which nozzle has a material line 16 that extends from a material inlet 18 for introducing the viscous material all the way to a nozzle opening 20 for exit of the viscous material. According to the invention, it is provided that the material line 16 has an inlet section 24 that extends in a first direction 22 from the material inlet 18, and an outlet section 28 that extends in a second direction 26, transverse to the first direction 22, to the nozzle opening 20, and that the application nozzle 14 is mounted on the nozzle holder 12 so as to pivot about a pivot axis 30 that forms a longitudinal center axis of the inlet section 24, and, in particular, so as to pivot back and forth.

1. An apparatus for applying a viscous material to workpieces, having a nozzle holder (12) and an application nozzle (14) arranged on the nozzle holder (12), which nozzle has a material line (16) that extends from a material inlet (18) for introducing the viscous material all the way to a nozzle opening (20) for exit of the viscous material, wherein the material line (16) has an inlet section (24) that extends in a first direction (22) from the material inlet (18), and an outlet section (28) that extends in a second direction (26), transverse to the first direction (22), to the nozzle opening (20), and wherein the application nozzle (14) is mounted on the nozzle holder (12) so as to pivot about a pivot axis (30) that forms a longitudinal center axis of the inlet section (24).

2. The apparatus according to claim 1, wherein the inlet section (24) and the outlet section (28) are rigidly linked.

3. The apparatus according to claim 1, wherein the second direction (26) runs perpendicular to the first direction (22).

4. The apparatus according to claim 1, wherein the application nozzle (14) has an equalization part (44) that extends transverse to the inlet section (24) and lies opposite to the outlet section (28) with reference to the pivot axis (30).

5. The apparatus according to claim 4, wherein the equalization part (44) extends counter to the second direction (26).

6. The apparatus according to claim 4, wherein the mass of the equalization part (44) approximately corresponds to the mass of the outlet section (28).

7. The apparatus according to claim 1, further comprising a motor (40) for pivoting the application nozzle (14) about the pivot axis (30).

8. The apparatus according to claim 7, wherein the motor (40) is firmly connected to the nozzle holder (12).

9. The apparatus according to claim 1, further comprising a feed line (48) for the material, which line is locally fixed in place with reference to the nozzle holder (12), and has an end section (54) that opens into the inlet section (24).

10. The apparatus according to claim 9, wherein the end section (54) has a longitudinal center axis that is a continuation of the longitudinal center axis of the inlet section (24).

11. The apparatus according to claim 9, wherein a circumferential first sealing ring (58), preferably composed of polytetrafluoroethylene (PTFE), is arranged between the end section (54) and the inlet section (24).

12. The apparatus according to claim 11, wherein the first sealing ring (58) lies loosely against an end face (60) of the inlet section (24) that faces the end section (54) and against an end face (62) of the end section (54) that faces the inlet section (24).

13. The apparatus according to claim 1, wherein a second sealing ring (64), preferably composed of an HDPE having an ultra-high molecular weight (PE-UHMW), which ring is fixed in place with reference to the nozzle holder (12), is arranged around the inlet section (24).

14. The apparatus according to claim 1, wherein the application nozzle (14) has an extension (34) that projects away from the side facing away from the inlet part (24), through which extension the pivot axis (30) extends.

15. The apparatus according to claim 14, wherein the extension (34) is connected to a drive shaft (42) of the motor (40).

16. The apparatus according to claim 14, wherein the inlet section (24) and the extension (34) are each mounted on the nozzle holder (12) in a rotational bearing (36, 38), respectively.

17. The apparatus according to claim 16, wherein a first one of the rotational bearings (36) is a ball bearing, preferably a double-row deep groove ball bearing or an angular ball bearing.

18. The apparatus according to claim 16, wherein a second one of the rotational bearings (38) is a body made of plastic, in which the extension (34) or the inlet section (24) is accommodated.

19. The apparatus according to claim 1, further comprising means (32) arranged on the nozzle holder (12) to limit a pivot angle (α) about which the application nozzle (14) can pivot about the pivot axis (30) with reference to the nozzle holder (12).

20. The apparatus according to claim 19, wherein the means (32) for limiting the pivot angle (a) are adjustable, so as to vary a maximum pivot angle.

21. A method for applying a viscous material to a workpiece, using the apparatus (10) according to claim 1, wherein the apparatus (10) is moved on an application path with reference to the workpiece, with the nozzle opening (20) at a distance from the surface of the workpiece, by means of a robot, and wherein the motor (40) is controlled as a function of the speed of the apparatus (10) with reference to the workpiece, so as to pivot the application nozzle (14) about the pivot axis (30), with reference to the nozzle holder (12).
